(19) United States
(12) Patent Application Publication
(10) Pub. No.: US 2009/0150224 A1
(43) Pub. Date: Jun. 11, 2009

(54) Television Traffic Estimation

(76) Inventors: Jeff T. Lu, San Francisco, CA (US); Ajoy Bhambani, San Francisco, CA (US); Thomas B. Bridgwater, San Francisco, CA (US)

Correspondence Address: FISH & RICHARDSON P.C., PO BOX 1022, MINNEAPOLIS, MN, 55440-1022, US

(21) Appl. No.: 12/332,024

(22) Filed: Dec. 10, 2008

Related U.S. Application Data
(60) Provisional application No. 61/012,707, filed on Dec. 10, 2007.

(51) Int. Cl. G06Q 30/00; G06Q 10/00

(52) U.S. Cl. 705/10; 705/14; 705/400

(57) ABSTRACT

A computer-implemented advertising management process includes receiving one or more indicators for a daypart or network on which to run a broadcast advertisement, and a proposed impression-based payment amount for running the advertisement, identifying one or more historical advertisement slots associated with the one or more indicators and applying the impression-based payment amount to advertising data for the one or more historical advertisement slots, and reporting an estimated advertising cost of running the advertisement using the impression-based payment amount and impression estimates derived from the advertising data for the one or more historical advertisement slots.

### RELATED APPLICATION

This application claims priority under 35 U.S.C. § 119(e) to U.S. Provisional Application Ser. No. 61/012,707 titled “Television Traffic Estimation” filed on Dec. 10, 2007, the disclosure of which is incorporated herein by reference.

### TECHNICAL FIELD

This document relates to systems and techniques for estimating television audiences, such as for use in determining an amount to bid for impressions of an advertisement.

### BACKGROUND

Broadcast advertising, such as via television and radio, is big business. Each year, the major television networks roll out their new schedules and hope to fill high-priced advertising slots for their new and existing programs. In order to determine where and when to buy ad time, advertisers may look at information about a program, such as ratings in a prior season and demographic information about an audience, which may have been obtained via a number of various mechanisms. For new programs, networks may present a target demographic to advertisers, and may use consumer testing to determine how well the show might do for ratings.

In such a situation, advertisers may be at the mercy of consumer whim, as ratings can change for a variety of reasons. For example, a program may have a huge opening and then lose viewers if its quality is not as good as its initial promotion. A program that has had strong ratings for a year may also start to slide in popularity after an advertiser has bought ad time. Also, for certain programs, such as sporting events, the number of viewers left watching a game near the end will be a function of how close the game is—for close games, the late-in-game advertiser gets a bargain, and for blow-outs, the advertiser gets little return.

### SUMMARY

This document describes systems and techniques that may be used by an advertiser in preparing a bid for running a television advertisement, such as a commercial, or other such promotion by which the cost is to be judged based on a number of viewers (e.g., a number of impressions for the ad). In general, an advertiser may log into an on-line advertising management system, may select a time slot or time slots and network or group of networks to carry an ad or ad campaign, and may enter a proposed bid for running the ad or ad campaign. The bid may be in the form of a per-impressions bid, i.e., paying a certain amount that depends on the number of people or televisions that were actually tuned into the broadcast (e.g., as determined, or estimated, by a viewer tracking service).

The system may take the provided information and compare it against information for the same network and time slot (or a similar network and/or time slot) from prior days, such as one week earlier on the same network, or another time at which the same or a similar program was on the same network or a different network. The bid from the advertiser may be applied to historical data regarding ads that ran during the prior matching time slot, to determine whether the advertiser's bid would have been enough to get the ad placed. The viewership, or impressions, associated with running the ad may also be generated as a prediction of the number of viewers that would watch the advertiser's ad in the coming time slot. The estimated number of impressions may then be applied to the proposed bid from the advertiser to inform the advertiser whether it is likely to succeed in an auction for the time slot, and the amount that the advertiser is likely to spend (based on future determination of actual viewership) for running the advertisement.

Such techniques may also recommend a bid price for an advertiser. For example, a price may be selected that will likely result in the advertiser getting the ad into an accepted position in a particular time slot, but a bid that is not so high that the advertiser would be spending too much. Other mechanisms may also be used to help the advertiser manage its ad spend, such as by allowing the advertiser to provide a budget that such spend cannot exceed. Also, high/low caps may be provided, so that if actual viewership is substantially higher than expected or substantially lower than expected (e.g., if the leading man in a sitcom becomes a major scandalous news item in the preceding week), the price to be paid by the advertiser changes but does not exceed, or fall below, particular amounts. With such a feature, the upside and downside risk to the broadcaster and to the advertiser may be lessened. The techniques described here can also be used by a sales force to generate proposals to advertisers, so as to provide the advertisers with an approximate amount that they would spend on a campaign.

In certain implementations, such systems and technique may provide one or more advantages. For example, potential advertisers may more readily understand the likely costs for running an ad when the ultimate cost is based on an uncertain number of future impressions of the ad. Advertisers may also be provided guidance regarding the appropriate price to bid to run an ad. The advertiser may be provided with such feedback via a simple user interface that can be used, in certain implementations, without the intervention of advertising professionals.

Such features may make it more likely that an advertiser will attempt such advertising approaches, and may thus draw more advertisers to broadcast media. That is a beneficial result for broadcasters and those who work with them. In particular, more bidders make for a more efficient market and may increase the prices paid for running advertisements. In addition, because such a system may be implemented so as to be easy to use, broadcasters can avoid the costs of hiring personnel to interact with advertisers and negotiate advertising rates.

In one implementation, a computer-implemented advertising management process is disclosed. The process comprises receiving one or more indicators for a daypart or network on which to run a broadcast advertisement, and a proposed impression-based payment amount for running the advertisement, identifying one or more historical advertisement slots associated with the one or more indicators and applying the impression-based payment amount to advertising data for the one or more historical advertisement slots, and reporting an estimated advertising cost of running the advertisement using the impression-based payment amount and impression estimates derived from the advertising data for the one or more historical advertisement slots. The historical advertisement slots can match the received daypart, and may match the received network also or alternatively.

In certain aspects, the historical advertisement slots match a program associated with the received daypart and network, and an episode of the program having a close match to the daypart or network. Also, applying the impression-based payment amount to advertising data for the one or more historical advertisement slots can comprise submitting the payment amount against payment amounts for advertisements that ran in the one or more historical advertisement slots to determine an auction-based payment amount for running the advertisement. The method can further include multiplying the auction-based payment amount by an impressions level corresponding to the one or more historical advertisement slots.

In yet other aspects, the one or more historical advertisement slots comprise an advertisement pod having approximately the same daypart as the received daypart, on the received network. In addition, the impressions level can be computed by adjusting a number of impressions for the one or more historical advertisement slots by a seasonal modifier. The method can also include generating a bid estimate for providing a determined likelihood of winning an auction for the received daypart or network, using bids of advertisements that ran in the one or more historical advertisement slots. Such generation may comprise computing a value between a highest and a lowest bid of advertisements that ran in the one or more historical advertisement slots.

In other aspects, the method further comprises determining a charge for an advertiser using a bid winning amount that is based on the impression-based payment amount, multiplied by measured, actual estimated impressions of the advertisement. The determined charge can be capped at an amount higher than the bid amount multiplied by the estimated impressions.

In another implementation, a computer-implemented advertising cost estimation system is disclosed. The system comprises an ad estimator interface to receive user input regarding advertising slots for the display of future advertisements, and bid amounts associated with the future advertisements, a historical impressions database storing impressions data associated with timeslots and networks, and a viewer estimator adapted to identify historical data, in the historical impressions database, associated with the user input regarding advertising slots and to estimate a number of impressions for the future advertisements using the historical data. The timeslots in the historical impressions database can correspond to advertising pods. Also, the viewer estimator can be adapted to compute an average impression level for a pod corresponding to the advertising slot.

In some aspects, the system can further comprise an auction simulator to apply the bid amounts associated with the future advertisements against bid amounts from the historical impressions database to determine an advertising position for the future advertisements. The system can also comprise an auction simulator to compute a suggested bid amount that is likely to generate a winning bid for the future advertisement.

In another implementation, a computer-implemented advertising cost estimation system is disclosed that includes an ad estimator interface to receive user input regarding advertising slots for the display of future advertisements, and bid amounts associated with the future advertisements, a historical impressions database storing impressions data associated with timeslots and networks, and means for computing estimated impression-based costs for the future advertisements.

The details of one or more embodiments of the advertising impression estimation features are set forth in the accompanying drawings and the description below. Other features and advantages of the features will be apparent from the description and drawings, and from the claims.

### DESCRIPTION OF DRAWINGS

FIG. 1 is a conceptual diagram of an exemplary process for estimating costs of an advertising campaign.

FIG. 2 is a block diagram of an illustrative advertising expense estimation system.

FIGS. 3A and 3B are flow charts of example processes for providing impressions data regarding television ad campaigns.

FIG. 4 is a swim lane diagram showing actions of various components in a television advertising system.

FIGS. 5A-5D are example screen shots from a system that provides interaction with television advertisers.

FIG. 6 shows an example of a computer device and a mobile computer device that can be used to implement the techniques described here.

Like reference symbols in the various drawings indicate like elements.

### DETAILED DESCRIPTION

This document describes systems and techniques for helping manage impressions-based advertising campaigns. Such techniques may include generating an estimate of future viewership of an ad so that the advertiser may have an idea of how much running the ad is likely to cost (because the cost is the product of a per/impression price and a total number of impressions). In addition, the techniques and systems may determine whether a particular bid from the advertiser is likely to win a position in an auction for ad time. Such techniques may involve applying a bid provided by a user against bids for ads that were run in a time slot corresponding to the time slot planned for the ad, but in the past. If the supplied bid is sufficient to win a slot in an ad pod for the past time period, it may be assumed that the bid will also win a slot in a future ad period (perhaps after some modifications have been made to adjust the past period to match the future period).

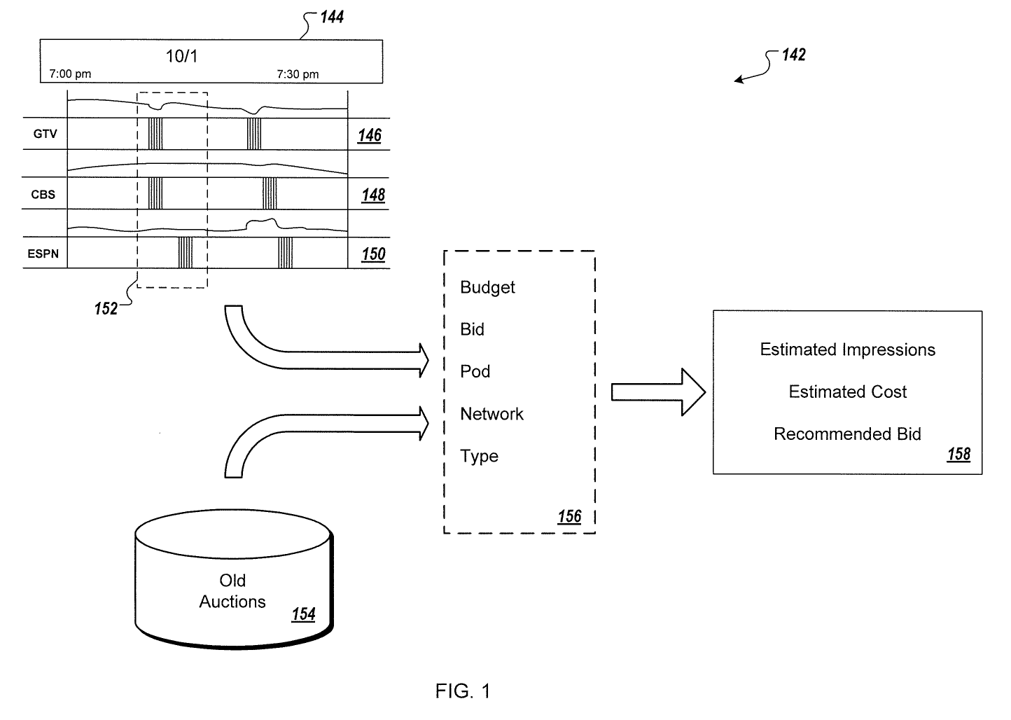

FIG. 1 is a conceptual diagram of an exemplary process 100 for estimating costs of an advertising campaign. In general, the process 100 shows the application of historical advertising data to proposed data that is provided by a user, so that estimates may be made concerning the impressions that can be obtained by advertising from the user, and concerning the resulting costs of obtaining those impressions. For example, the user may be an advertising representative for a company seeking to place video commercials on various television networks on a national basis. The advertising may be placed, in cooperation with the networks, by an auction process, by which advertisers bid certain amounts to have their commercials shown, and the advertiser or advertisers with the highest bids are the advertisers who have their commercials shown.

The payments for showing commercials, and the bids for showing their commercials, may be computed in terms of a number of actual impressions provided by the network for the advertiser. For example, various mechanisms, such as set-top boxes, paper reporting forms, and other similar mechanisms, may be used to gauge the size of an audience for a program, and for commercials that are run during the program. The advertisers may agree to pay a set amount for every 1000, 10,000, or 100,000 viewers or impressions. The set amount may be constant for each additional viewer, or may follow various formulas, such as a formula that provides a decreasing per-user price for each additional viewer.

By this process, advertisers may more closely correlate their advertising spending to the benefit that they receive from the advertising. Specifically, if few viewers watch a commercial, the advertiser will spend proportionately less money running the commercial. If a large number of viewers watch the commercial, the advertiser may pay more to run the commercial, but the ad will have greater effect. In this manner, the advertiser and broadcaster share both the risk and the reward in placing advertisements, and the cost of advertising more accurately reflects the benefit received by the advertiser.

Because the amount to be paid by the advertiser varies with a factor that is in the future and is not under the control of the advertiser (the viewership of the program or ad), the advertiser may have difficulty determining how much it will cost to run a particular ad. As a result, the advertiser may not readily know whether it can afford to bid for a particular ad slot, even if it knows what it is willing to pay for a particular number of impressions.

The process 100 shown here may be used to help the advertiser, or another party, estimate the cost of placing one or more future ads, so that the advertiser may better select programs and timeslots for advertising, and may better understand how long its ad budget will last as part of an advertising campaign. In addition, the process may suggest a bid that the advertiser should make for placing an ad, where the bid has a reasonably good chance of being successful without spending too much money. The process may also provide an advertiser with an indication of the odds that an ad will run, given a particular bid and/or budget for the advertiser.

Working backward from the final product of the process 100 to its inputs, the process 100 provides, as outputs 116, an estimated number of impressions that an advertisement or an ad campaign will generate, an estimated cost to the advertiser for running such ads, and a recommended bid for the advertiser to make for presenting an ad. This information may be helpful to an advertiser or to another party, in that it may assist the advertiser in understanding approximately how much an advertising campaign will cost, and what kind of effect can be obtained with the advertising campaign. In addition, various inputs to the system, discussed in more detail below, may be changed by the advertiser, in response to such outputs 116, to identify other possible costs and viewer impressions that may be obtained for an advertising campaign. In this manner, the advertiser may readily determine and experiment with a combination of advertising factors so as to maximize an advertising return on investment (ROI) for a campaign.

The illustrated outputs may be generated by the process 100, by applying a number of inputs supplied by the advertiser to certain historical data regarding advertisements that have been shown, the reach or impressions provided by those advertisements, and the cost of those earlier advertisements. For example, advertiser inputs 114 may be data entered by an advertiser and may include a number of factors that are important to a typical advertiser. For example, an advertiser may provide a total budget for a campaign, as an indicator of a level of spending that the advertiser does not want to exceed. The advertiser may also include one or more bids for running of advertisements. For example, the advertiser may indicate that it is willing to spend a certain number of dollars per 1000 viewers for an advertisement on a particular network at a particular time window, or time slot. Such a bid may be employed in an auction process against bids from other advertisers seeking to place content on the same networks during the same time slot, where the highest bidder (or bidders) wins the auction, and has its ads run during the slot.

An advertising time slot may take various forms. For example a time slot may envelop a time range in a programming day, such as a two or four-hour range of time. One exemplary such time range includes prime time television, and the hours covered by the time slot may vary from time zone to time zone. Also, the time slot may be directed toward a particular commercial break during the broadcasting of programming. Such a commercial break may include one or more commercials, and may be referenced as a “pod.” Generally, a pod is broken up into a series of thirty-second commercial segments, though shorter or longer commercials may be run. Other time slots may also be used, such as when advertisements are superimposed over a running program. For example, an advertisement may be displayed while the credits of a television program are running. Also, an advertisement may be scrolled across the bottom of a screen much like a news ticker, or may be provided as a bug that appears in the corner of programming and then disappears after a time. The beginning and ending times for showing ads in such manners my be considered time slots. These different manners of displaying an advertisement—such as different-length commercials, overlays at bumper portions of a program, or overlays on the program itself—may be referenced as a type or format of the advertisement, and may also be specified by an advertiser when a system supports multiple such ad types.

An advertiser in this example has provided an identification of a particular pod in which it would like its advertising to appear. As shown below, the advertiser may also select additional time slots—either for a single ad or for multiple different ads. In addition, the advertiser may indicate a network on which it wishes an advertisement to run during the particular time slot. Such a network may include particular broadcast networks, such as ABC, CBS, NBC, Fox, ESPN, the WB, and various cable channels. Generally, advertisers will seek to identify a network whose viewership is consistent with the target demographics of an advertising campaign. For example, companies advertising male hygiene products may identify ESPN as a target network.

The inputs 114 may be for a single advertisement in a single timeslot, or for multiple advertisements across a complex advertising campaign for multiple timeslots and networks. A combination of timeslot and network, which may identify a particular instance of television programming from among all the many other instances of programming, may be referenced as a “target.”

Each of the various inputs 114 indicates a desired parameter provided by the advertiser (or by some other entity or mechanism) for its advertisement. The process 100 may then apply certain historical data to the inputs 114 from the advertiser in order to generate the outputs 116 for the advertiser. In general, the historical data includes viewership or impression data for time slots similar to the time slots selected by the advertiser, and bid data for various bidders who were seeking and obtained placement for their ads during the historical time slots.

Viewership data is shown at graphs 102, which shows three networks between 7 p.m. and 7:30 p.m. on October 1. The timeline between 7 p.m. and 7:30 p.m. is divided, for each network, into segments, where each segment represents a display of programming, or a display of commercials. In this example, hatched areas represent periods in which commercials are run, while white areas represent programming. As can be seen, each network generally includes commercial breaks during similar, though not identical, periods of time. Also, for each network, a graph is shown for viewership data during that period, i.e., a line graph showing the number of viewers (or the number of televisions) at a particular time. Such viewership data may be obtained by various mechanisms, such as set-top boxes, other electronic tracking, manual paper tracking, surveys, and other mechanisms for determining viewership of television programming.

As can be seen for the Gtv network 104, a program initially has relatively high ratings, the ratings dip during a first commercial break, they recover after the program returns, they dip again during a second commercial break, and the ratings generally fall during a last segment of the program. A program on CBS 106 generally has increasing ratings during its early period—even during commercial breaks—but then tails off at the end, perhaps because viewers did not enjoy the program. A program on ESPN 108 indicates relatively low viewer interest during the early period, followed by high viewer interest, which then deteriorates during a second commercial break. For instance, perhaps ESPN was showing a sporting event that became very close late in the game (driving ratings up) but was decided just before the second commercial break (causing people to tune out).

The zone 110 shows an area of pods for each network. Although the timing for each pod on each network varies slightly, general timing of the pods can be determined based on general practices of network programming operators. In this example, the viewership data for the zone 110 is used in helping to predict or estimate impressions for the advertiser, such as because the relevant time slot in 102 corresponds to the pod indicated in inputs 114. For example, the advertiser may have identified ESPN on Monday night as a preferred location for running an ad, and the process 100 may have identified the data from Monday, October 1 as corresponding to such a timeslot.

The corresponding pods may be selected in various manners so that they will approximate, or are expected to approximate, future viewing patterns. For example, a pod from a previous week on the same weekday at the same time, and on the same network, may be selected in a simple example. Also, pods from several prior weeks may also be used in analyzing viewership. Where multiple such pods are used, the pods may be weighted, so that more recent viewership numbers are more significant than more distant viewership numbers. In such a manner, recent performance of a network program may have a greater effect on an estimate of future viewership for the program.

Also, various modifications to the viewership may be provided once the historical viewership numbers are obtained. For example, where viewership levels change across the duration of a pod, such as where viewers tune out during a commercial break, the average viewership across the pod may be used. Alternatively, or in addition, when a position within a pod has been determined for a particular commercial, impression data for that particular portion of the pod may be used to provide an estimate.

Also, viewership numbers are generally seasonal, with higher viewership during fall months, and lower viewership during summer months when programs are being repeated. As a result, seasonal modifications may be made to viewership data. For example, if an advertiser is seeking estimates on viewership during September, and the historical data is from August, an adjustment factor may be applied to the data to represent typical seasonal changes between August viewership and September viewership. For example, it may be known that, historically, existing situation comedies receive a 20% increase in viewership between August and September, so that such an adjustment may be applied to the data recovered by the process 100.

The process 100 may also determine whether an advertiser is likely to have its advertisement selected for display during a future period, determine where in a pod the advertisement will be displayed (e.g., when the pod has room for several advertisements), and determine a likely cost for displaying the advertisement. Such information may be determined using information from prior, old auctions 112. Such information may include, for example, bids that were provided by advertisers who had their advertisement selected for display in the prior historical timeslot. For example, if inputs 114 include a bid for three dollars, and four commercials were shown during the prior pod, whose bids ranged from $2-$5, the advertiser may be assumed to be a successful bidder, so that its advertisement may be shown in the future timeslot, barring any changes in advertiser behavior since the historical period.

The particular price that is needed before an advertisement will run may be a cost that is lower than the bid price. In particular, the bid may be considered a maximum amount that the bidder is willing to spend, but the actual amount charged to the bidder may be the amount bid by the top losing bidder or a similar amount (e.g., slightly more than the top losing bidder), or an amount bid by the next highest bidder.

As one example, the table below shows bids from five different bidders for a four-ad pod, and the amounts each actually pay under three different bidding models. In the first model, the bidders pay the amount of the next-highest bidder, and the highest bidder is rewarded with the first slot (which presumably has the most viewers and the greatest impact). In the second model, each winning bidder pays the same as the highest losing bidder, and the slots are assigned randomly, or the highest bidder gets the first slot even though it pays nothing extra, as a reward for taking a greater risk. In the third model, each price is seven percent more than the next highest bid, but not to exceed the amount of the bidder's actual bid.

| Bidder | Bid | Price/Slot (A) | Price/Slot (B) | Price/Slot (C) |
|---|---|---|---|---|
| A | $4.00 | $3.75/1 | $3.00/3 | $4.00/1 |
| B | $3.75 | $3.50/2 | $3.00/4 | $3.75/2 |
| C | $3.50 | $3.25/3 | $3.00/2 | $3.48/3 |
| D | $3.25 | $3.00/3 | $3.00/1 | $3.21/3 |
| E | $3.00 | Out | Out | Out |

Using one of these models or another model, an advertiser's proposed bid for a future advertisement may be inserted into an advertising auction against bids from a prior time slot, and its position within a pod may be determined. If the ad succeeds in the auction, the impressions for the ad may be determined from the appropriate network 104-108 in graphs 102. The impressions may be taken at various levels of granularity. For example, the ratings for the program may be used (and, depending on the number in which the rating is expressed, the rating may be modified to reflect the technique for expressing impressions that the bid was placed in). Alternatively, ratings may have been measured periodically through a program, so that the rating measured closest to the relevant pod may be used. In very close granularity, the ratings for a particular ad slot within a pod may be used. Such determinations, perhaps accompanied by modifications to make them more reflective of actual general viewership conditions, may then serve as an estimate of future viewership. The ranking of bids may be modified in various manners. In one example, the quality of an ad may affect the ranking of the ad. In particular, if the ad is “sticky”—meaning that few viewers change the channel while the ad is running—the ad may be given a higher score for ranking purposes, where its score would then be a combination of the price bid and the quality of the ad. Sticky ads are good because they retain viewers for a program, and such ads may thus be rewarded by a broadcaster giving them a higher score. Sticky ads are also good for viewers because the viewers presumably stick around because they enjoy the ads. And sticky ads are good for advertisers because those viewers are likely paying attention to the ads, and are thus more likely to convert into actual purchasers of the advertised product or service.

The stickiness of ads may be determined in various ways. As a simple way, where highly granulated rating data is available, the percent reduction in viewership from the beginning of an ad to its end may be used as a determinant of stickiness. Adding some complexity, changes in viewership for an ad when it is run first in a pod may be more important than changes when it is late in a pod because viewers generally decide whether to stay or channel surf immediately in the pod, and also because ads late in a pod may actually have a gain in viewers, not because the ad is any good, but because channel surfing viewers are trying to get back in time for their main program to start again. Various statistical mechanisms may also be used to disassociate data about an ad from user reactions to other ads when all of the ads are run in a common pod. By these various mechanisms, the quality of an ad in terms of its ability to maintain impressions, may be determined, and such quality may be rewarded with better positioning of the ad. Such rewarding of quality may be considered to be analogous to the combined bid and click-through scoring of ads in the GOOGLE ADWORDS program.

In certain circumstances, a recommended bid may be returned for the bidder. Such a recommended bid may be computed using the historical data, so as to produce a bid that is likely to win a future auction. In a simple example, a certain percentage of the successful past bids for a time slot may be used—such as a 50^{th} or 75^{th} percentile. A number of different bids may also be generated, and each may be associated with a likelihood that the bid will be a success (i.e., where the bids and the likelihoods of success may be returned to a user). Also, initial suggested bids may be modified in certain circumstances, such as to reflect general increases in bids between the time of the historical data and the time of the slot for which bidding is occurring.

Each such determination may then be returned to the user in outputs 116. As noted above, the computed cost per unit of impressions may be multiplied by, or otherwise combined with, the estimated impressions to determine an estimated cost for the advertiser of running the advertisement. The user may be presented, as discussed in more detail below, with the impressions (expressed by various measures) that the ad is predicted to receive, a predicted cost for running the ad, and in certain circumstances, a recommended bid.

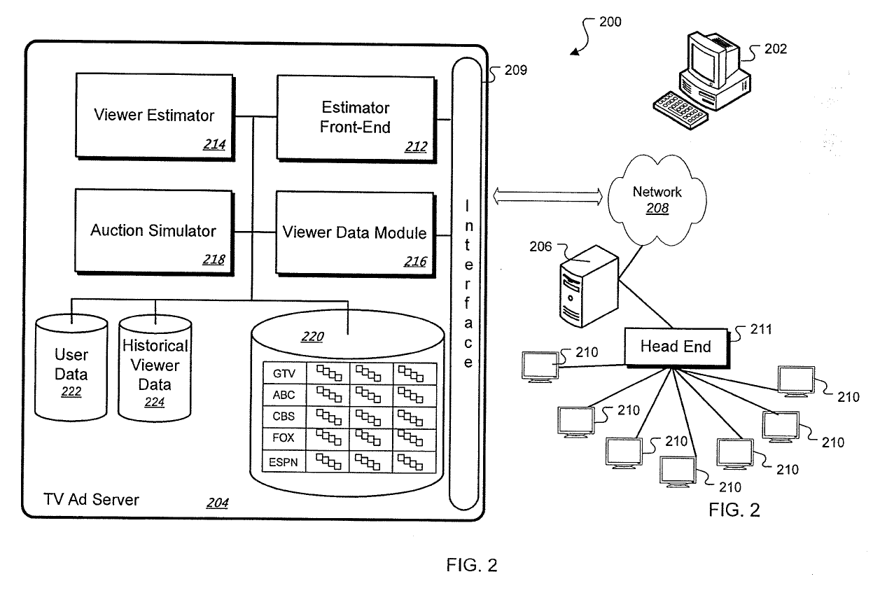

FIG. 2 is a block diagram of an illustrative advertising expense estimation system 200. In general, the system includes a TV ad server 204 that contains a number of structural components for estimating viewership and other factors relating to a TV ad to be run in the future, and for generating an actual cost for the ad after it runs. The ad server 204 communicates, through a network 208 such as the Internet, with a number of external components in performing such actions, including an advertiser terminal 202 where an advertiser may interact with the system 200 in establishing one or more ad campaigns, and a viewer rating server 206 that may report numbers of actual viewers or households that watched a particular program or portion of a program.

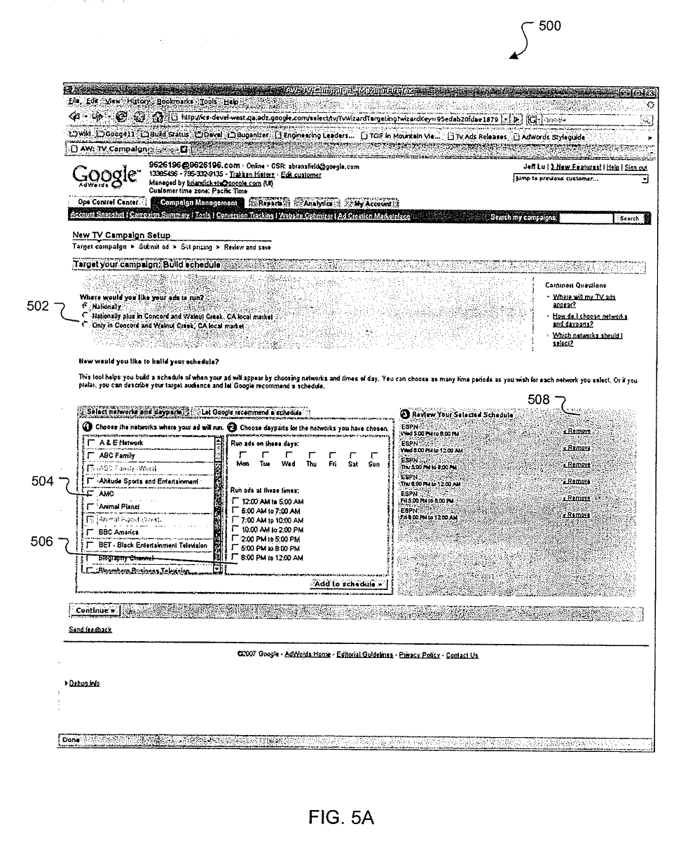

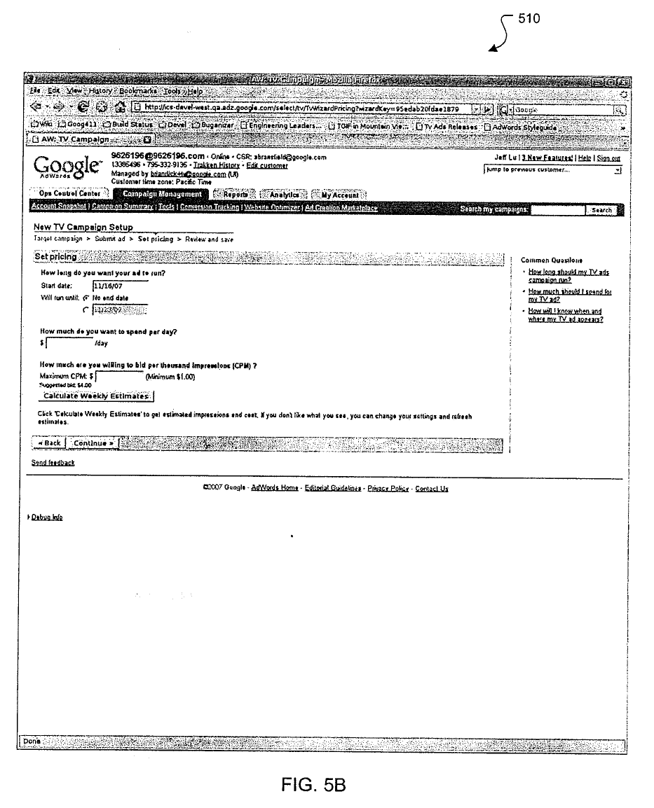

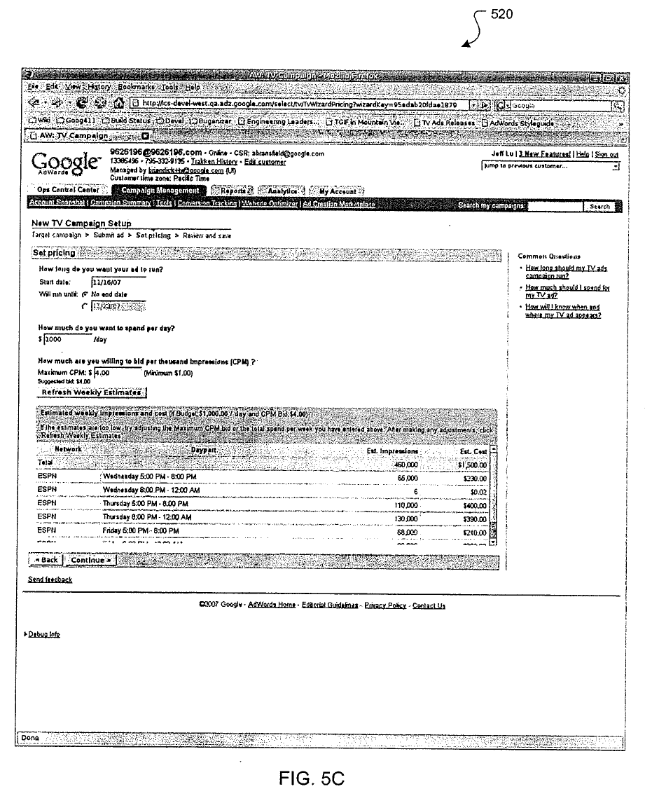

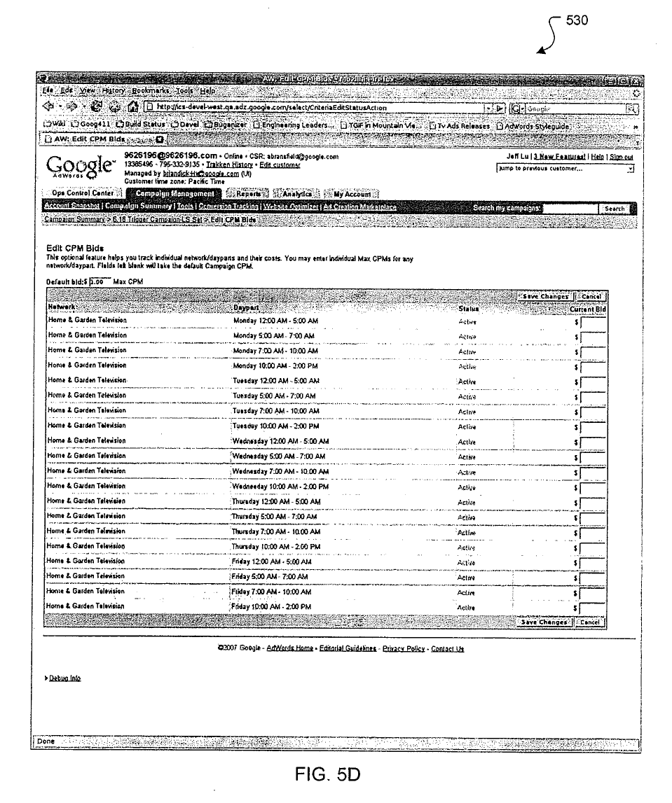

The advertiser terminal 202 may take a variety of forms, such as a personal computer connected to the ad server 204 using a particular application or a web browser displaying an application. Using the terminal 202, an advertiser or other party may manage ad campaigns by entering budget information and bids for the running of ads. The party may also identify time slots and networks where they would like to run ads and may additionally upload electronic files of the ads or provide pointers to locations (e.g., URLs) where the ads may be accessed by the system 200. Various other interactions, such as those shown in FIGS. 5A-5D and discussed below, may also be performed from the terminal 202.

The ad server 204 contains a number of components for facilitating such interaction with users of the system 200. For example, an interface 209 receives requests from users and formats responses. The interface 209 may be or include one or more web servers or other appropriate mechanisms. An estimator front-end 212 may generator display information for an ad estimation application and may respond to user inputs for such an application. The display information may include, for example, mark-up code such as HTML code, style sheet information, and code such as JavaScript. In addition, the estimator front-end may makes calls upon various other components in the ad server 204 and may calculate a variety of parameters related to providing ad estimation for users of the system 200, as discussed above and below.

The estimator front-end 212 and other components in the ad server 204 may draw upon a variety of data sources. Such sources includes a source of user data 222, which may store information about particular users and their advertising accounts. For example, user data 222 may store identifying information for advertisers, financial account numbers from which money for the advertisers may be drawn, identifiers for time slots during which the advertiser has scheduled ads to run, and other such information needed to adequately track ad reservations and ad payment, among other things.

The store of historical viewer data 224 may include data that reflects viewership levels for various programs in the past. The data may represent viewership in various manners, such as by a number of viewers determined by paper surveys or a number of televisions in operation during a given period (perhaps modified to reflect a number of viewers in front of those televisions). Electronic collection of viewership data may occur using a viewer data module 216 that aggregates and formats data received from one or more viewer rating servers 206. The viewer rating server 206 may be operated by various entities, such as a cable or satellite television provider. The server may receive information from a head end 211 that is in turn connected to a large plurality of devices such as set top boxes 210. (The set-top boxes need not literally be on top of a television, and can be integrated with the actual television itself.) The set-top boxes may periodically report viewership activities in a variety of well known fashions and the viewer rating server 206 may aggregate the received information to provide an overall viewership number for a program. Such viewership may be reported for various increments, such as for an entire program, at five minute increments, or at thirty second increments or less. The amount of time between reporting incidents may be a factor of the bandwidth needed to perform such reporting, the storage space permitted for the reporting data, and the needs of a system with respect to such gathered data, among other things.

The viewer rating server 206 may report to the viewer data module 216 various forms of viewership data. For example, raw viewership numbers may be reported for each network during a particular time period. In addition, demographic data may be reported, such as personal data about groups of viewers (e.g., general demographics of subscribers, the packages those subscribers receive (with the inference that subscribers to premium channels have more disposable income), and other such information). Also, data about the other channels that were viewed by particular boxes may be reported, so as to permit analysis of where viewers were going and where they were coming from during a period. Such tracking data may be useful, for example, in determining which ads are sticky and which are not.

The viewership data reported by viewer rating server 206 may be anonymized. For example, reporting of data may occur using identifiers that cannot be tracked to particular users, or may occur by reporting on groups rather than particular users.

Schedule database 220 stores information about television programming schedules and ad slots in those schedules. Such information may include past and future schedules. The schedule database 220 may include, for example, typical data about programs that may be obtained from commercial services, such as program duration, program titles, program descriptions, networks (and channels) carrying a program, main actors in a program, timing of commercial breaks during a program, and other such information. The schedule database 220 (or, as with other data sources described here, another database or databases) may also include information about pods in programs and about ads carried in past programs (and in some instances, bids for ads in future programs, and ads to be carried in future programs after an auction has closed but before a program has aired). Such ad information may include identities of ads and advertisers, bids made by the advertisers to run the ads, and actual prices paid by the advertisers to carry the ads (i.e., before or after group and other discounts may have been applied).

The information in the various data sources may be used by viewer estimator 214 and auction simulator 218 to determine a projected or predicted number of impressions for an ad that is to be run in the future and a price for that ad (or the success or failure of a price that is provided by a user). The viewer estimator 214, for example, may be directed to a particular time slot, such as by the estimator front-end 212, and may query the historical viewer data 224 to obtain viewership data for the time slot, such as for various ads that ran during a time slot. The viewer estimator 214 may then, using techniques described above and below, provide an estimated viewership level for an ad to be run during a future time slot selected by a user.

For its part, the auction simulator 218 may access historical bid data for time slots such as slots identified by estimator front-end 212. The historical bid data may include bids offered for running ads during the time slot by advertisers who succeeded in having their ads run, and in certain circumstances, also bid data from unsuccessful advertisers. The auction simulator 218 may take the historical bids, and also take a bid presented for an auction for a future time slot, and may compare the bids to determine whether the bid for the future slot would have succeeded if it had been presented in an auction for the prior slot. The auction simulator may then return various data to estimator front-end 212 or another module, such as whether the bid would have been successful, the bids of other successful or unsuccessful bidders, and other similar information.

The estimator front-end 212 may determine which time slots or pods to analyze in making various estimations, and may direct the other components of the system server 204 in accessing such information, as just described. For example, if the estimator front-end 212 determines that an advertiser has selected to run an ad at 7:00 pm December 21 on network XYZ, then it may identify, as comparable historical time slots, shows starting at 7:00 p.m. on network XYZ on December 14, and perhaps December 7 also. The estimator front-end 212 may also perform additional analyses, such as by identifying the television program being aired at the time selected by an advertiser and finding the most recent airing of the program on the same network, or the airing of the program on the same network that most closely matches the time of the future airing.

The estimator front-end 212 may also receive information back from other modules and present it for review by a user. Such presentation may include showing likely viewership levels for an ad, and costs of running the ad. In addition, the estimator front-end 212 may include such information for a number of different ads in a single ad campaign or multiple ad campaigns.

The estimator front-end 212 may also identify particular time slots for an ad in response to the provision of information about the ad. For example, an advertiser may enter certain demographic information about the ad, a proposed budget for running the ad, and a proposed goal for an ad campaign (e.g., maximizing brand awareness, hitting targeted viewers, etc.). The estimator front-end 212 may in turn identify multiple various ad slots to achieve the goal while keeping within the budget. Where the number of ad instances to be run is high, the system 200 may also be programmed to lessen the risk for an advertiser, such as by provided protection against ads that receive many more viewers than expected.

In addition, the estimator front-end 212 may perform follow-up functions, such as by returning, after-the-fact, to obtain actual impression numbers from viewer data module 216 and to multiply such information by a cost for running the ad that has been determined by an auction process for the ad. The front-end 212 may then cause the advertiser's account to be debited for the running of the ads. Various other approaches to scheduling, provisioning (e.g., via auction or otherwise), and accounting for running of ads may also be employed using system 200.

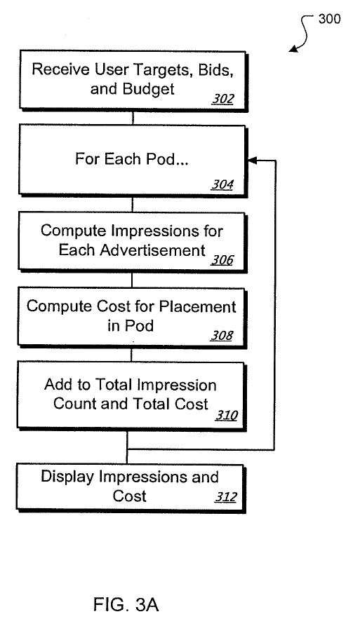

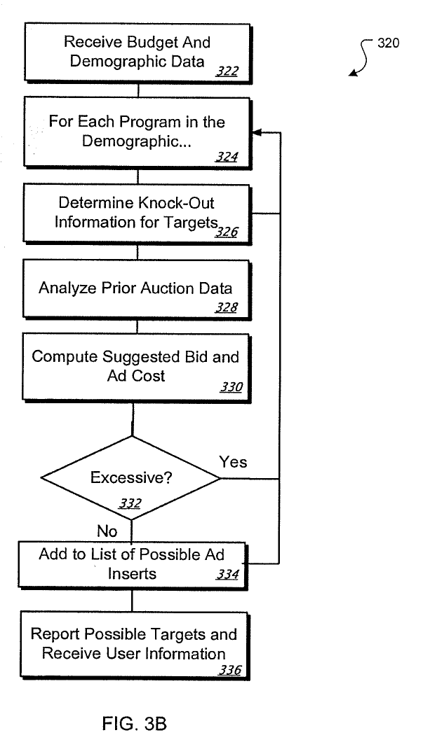

FIGS. 3A and 3B are flow charts of example processes 300, 320 for providing impressions data regarding television ad campaigns. FIG. 3A generally shows a process 300 by which a system determines predictive placement and costs for broadcast advertising that is billing based on a measure of viewership of the advertisements. The process 300 involves receiving a number of inputs, such as from an advertiser or other user, or from an automated placement process, and then computing a number of predictive factors such as impressions and costs, using historical data that is relevant to advertising slots sought by an advertiser or other user.

At box 302, the process 300 receives user targets, bids, and budget. The user targets may include a time slot and a network, among other things. The time slot may be stated in various manners, and may be selected by a user or a program according to a number of available slots that the process 300 presents to them. For example, the time slot may comprise the time during which a particular program is airing, a set spot that includes perhaps more than one program, or a particular pod or slot within a pod. The bids are the amounts, per impression or other similar measure, that an advertiser is willing to pay to have an ad broadcast. The budget is the maximum amount that an advertiser is willing to pay, and may indicate an amount for an entire advertising campaign, for the carrying of a particular ad in multiple instances, and/or the carrying of a single instance or showing of an ad. Using such information, and in particular the targets, the process 300 may identify a number of pods in which the advertiser's ads may be run.

At box 304, the process 300 begins an iterative progression of identifying particular targets and making certain determinations for each such target. For example, the number of impressions or a similar indicator may be computed for each ad to be carried, such as by determining a number of impressions or other such ratings measure for a prior corresponding showing of ads or multiple such showings, and providing adjustments, if any, to such prior numbers. A hypothetical auction may also be carried out between bids provided by an advertiser to run its ads in the future, and bids provided in the past by advertisers for similar ad slots. If the auction indicates that the advertiser will likely win an auction, then a cost for running the ad may be computed. The cost may be, for example, the bid of the next-highest bidder below the advertiser.

From such information, a predicted cost for placing the ad may be determined, such as by multiplying the number of impressions by the cost per impression. Such a computed cost may also be modified, such as to take into account group discounts, changes in predicted viewership from period to period, or other such factors. With figures for each ad determined, those figures may be saved and a running total for impressions and costs may be computed. Once all of the ad instances have been reviewed, the process 300 may return to a user, or a system associated with a user (e.g., a system that analyzes television schedule data to automatically select different networks and time slots), all of the data for review, including a total number of impressions for an ad campaign or for each ad within a campaign, along with a total cost for the campaign and/or each ad within a campaign.

FIG. 3B shows a flowchart of a process 320 for obtaining bid amount data for an advertiser. In general, the process 320 involves an advertiser or an agent of an advertiser (including an automated program) providing parameters to the process 320 for an ad campaign, and the process 320 identifying ad slots for placement of the ad and suggested bids for the advertiser to submit in order to win placement in the ad slots.

The process starts at box 322 by a user or other entity providing a budget and demographic data for an ad campaign. For example, the user may indicate that they have $200,000 available for the campaign, and may indicate that they are trying to reach active retirees. At box 324, the process 320 identifies a number of television programs whose viewership matches (or is at least aimed at) the identified demographic. Such a match may be determined by a simple look up function, where a database includes a listing of all programs airing over a certain future period and a number of demographic keywords assigned to each program.

The process 320 then begins an interactive cycle for each of the identified matching programs. In a first step of the cycle, the process 320 first determines whether certain knock-out information for the program clearly indicates that it would not be an appropriate program for the ad, so that further calculations need not be made. For instance, if the budget is relatively low, and the network is a popular national network—where a system might store information showing that no commercial has ever run on the network for a total cost that is within the budget—the particular program (and the entire network) may be eliminated from contention.

If an initial knockout process does not eliminate a program or a pod from contention, the process may at box 328 analyze prior auction data so as to determine a price that will likely be needed to win an auction for a particular ad slot during a program or a pod. For example, a particular percentile bid may be selected or a weighted bid (i.e., if most bids are very high and only one winning bid was low, the suggested bid can be weighted toward the high end) may be computed. At box 330, the cost of running an ad during the prior time period using the suggested bid may be determined. For example, a per viewer cost may be determined, and a viewership level may be obtained from historical viewer data.

If the computed costs (e.g., cost per viewer times number of expected viewers) exceeds the advertiser's budget, the particular target may be excluded from consideration (box 332), and the cycle may begin again with a new target. If the computed costs are low enough, the particular target, along with expected impressions and suggested bid amount, may be added to a list of possible ad placements for the campaign.

Once all of the possible targets have been reviewed, the process 320 may present all acceptable targets to the user (box 336). Such a report may include a table showing target information (e.g., network and time slot), viewership levels, and total costs of running an ad once at the target. The user may also interact with such information, such as using AJAX techniques in a web browser implementation, and may tentatively select certain targets for running of an ad. A budget calculator may be provided to track such selections and to show the user the budget that will be used up by their cumulative selection of targets. In addition, other information may also be provided, such as the level of audience coverage provided by the various target selections (e.g., if the same group of people watch various programs targeted by an advertiser, the coverage will be narrow but deep, whereas if the advertiser selects a variety of programs that appeal to a broad swath of viewers, then coverage will be broader but shallower). Other such advertising statistics may also be provided to the user. Again, in this example, the user may be a person such as an advertiser representative, or a system, such as an automated ad placement system.

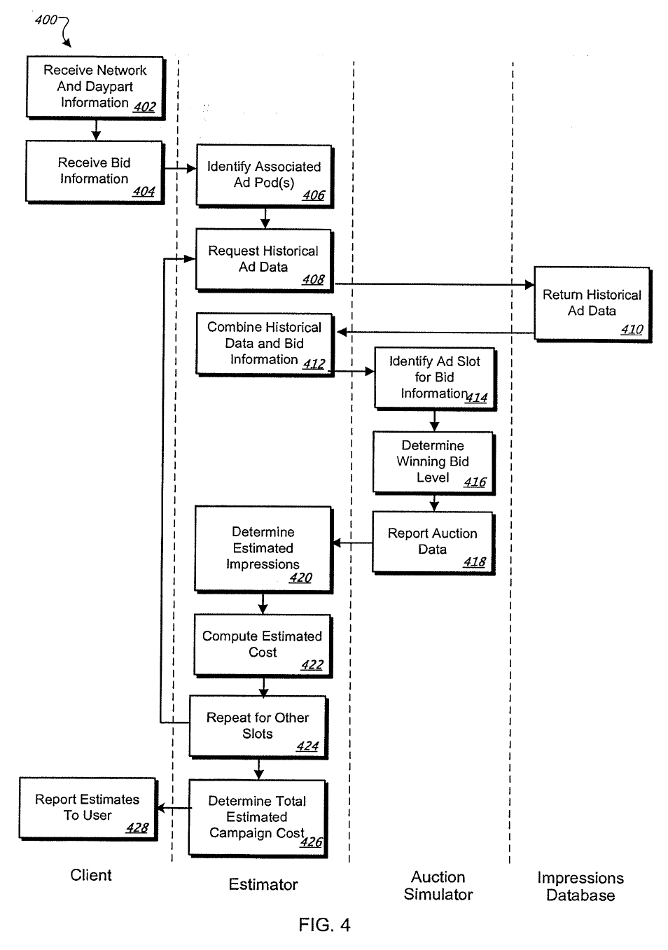

FIG. 4 is a swim lane diagram showing actions of various components in a television advertising system. The process 400 in the figure generally includes actions similar to those described with respect to prior figures, but additionally shows particular actions that may be performed by individual components in a system. Of course, other components may perform the actions shown in this example, and components may be combined or split apart as is prudent in a particular implementation.

In this example, four such components are depicted, including a client device, an ad estimator, an auction simulator, and an impressions database. The client device may include a variety of computing devices such as a personal computer or other device operated by an advertiser or another party, or by an automated system. The ad estimator may be a component of an advertising server system that provides advertisers and other users with information about advertisements, including predictions about viewership levels for advertisements that are to be run in the future. The auction simulator may include a number of components that provide information about expected costs for having an advertisement placed in a particular target location. The impressions database may include data indicating a number of viewers who watched prior programs and/or advertisements run during the programs. The impressions database may represent viewership data in various manners, such as a number of televisions tuned in to a program at different times, and may also break the data about viewership into various sized chunks, such as program-sized chunks, and smaller chunks, such as 15 minute chunks, one minute chunks, and thirty second chunks, among others.

At box 402, the client device receives daypart and network information for an advertisement or advertisement campaign. Such information may identify particular television networks on which ads are to be run, and times in the day when they are to be run. The daypart information may be focused, for example, on large portions of the day such as several hour portions, or upon particular programs shown during a day. The network and daypart information may be provided manually, for example, by an advertiser logging into a network accessible system and entering the information on a web page form. Information may also be provided automatically, such as by a batch upload of scheduling information entered by an advertiser, or by passing information from an automated advertisement management system, such as by transmitting XML code.

At box 404, the client device receives bid information. The bid information may include viewership-based bids for running of certain ads. For example, the viewership-based bids may include bids that present dollar amounts tied to certain levels of impressions provided by an ad. Again, the bid information may be received manually or automatically, in ways similar to the reception of the network and daypart information.

At box 406, the received information from the client device is passed by the client device to the estimator. The estimator identifies associated ad pods for the submitted information, such as by identifying pods for the same network and daypart that were identified by the client device but for a period that is one week earlier than those identified by the client device. At box 408, the estimator requests historical ad data for the particular pods or associated time periods from the impressions database, and at box 410 the impressions database returns such historical data. For example, the impressions database may include ratings information for various programs and ads shown during past periods, and may return such information in response to identification of particular network and timeslot data.

At box 412, the estimator receives the historical ad data and combines that data with the bid information received from the client device. The estimator then provides such information to the auction simulator, which, at box 414, identifies an ad slot for the bid information. The auction simulator may then retrieve bid information from other bidders for the ad slot, which may be a historical ad slot. The auction simulator may then determine a winning bid level, at box 416, for the ad slot, and determine whether the bid information provided by the client device would result in an ad for the client being shown on the network. In addition, in appropriate circumstances, the auction simulator may select a suggested bid price that is at a pricing level likely to result in a successful running of an ad, but is not guaranteed to do so. The auction simulator then, at box 418, reports the auction data back to the estimator.

At box 420, the estimator begins making a number of determinations for that particular pod, such as by estimating a number of impressions for the ad. In a simple case, the number of impressions may match the historical viewership data obtained from the impressions database. In more complex scenarios, the impressions data may take into account the position of the ad during an ad slot, such as to reflect diminishing viewership over the course of an advertising break. Other adjustments may also be made to historical impressions data to create an estimated impressions figure.

At box 422, an estimated cost for running the ad during the pod is computed. The estimated cost may be the product of the estimated number of impressions and the cost determined for the ad during the auction process. The various steps for identifying data for an ad pod, and computing various costs and viewership figures for running an ad during a future related pod may then be repeated, as indicated by box 424. When all such pods have been reviewed, a total estimated campaign costs may be determined at box 426 by the estimator. The total cost may include the sum of all costs for the various pods that were analyzed.

Information is then returned to the client device which reports the various estimates determined for the future ad campaign to a user at box 428. Such information may include a variety of figures that are important to an advertiser, such as total cost of an ad campaign, the coverage of the campaign, the number of airings of each ad that may be carried in a campaign, the total number of impressions and subset of the number of impressions for each ad, and other such information.

FIGS. 5A-5D are example screen shots from a system that provides interaction with television advertisers. FIG. 5A shows a setup screen 500 for a new television advertising campaign. The screen permits a user to identify various targets for an ad campaign, where the targets include a network and a time slot for the running of ads.

Area 502 permits the user to identify certain geographic regions for running a campaign, since a local furniture company probably would not want to pay for a national ESPN slot. The system may have remembered a location previously entered by the user—here, the Concord and Walnut Creek, Calif. area. The screen 500 permits the user to select national placement only, local placement only, and a combination of national and local placement. Such a selection permits the system to then identify certain time slots on particular networks that are reserved for local advertising versus national advertising.

The other areas of the screen 500 then permit the user to identify network and daypart target information. Data entry box 504 lists a number of networks that a user may select, and data entry box 506 permits selection of dayparts associated with each selected network or group of networks. Here, the dayparts are rather broad, and include several-hour segments of each day. Review box 508 shows the results of the selections in boxes 504 and 506, in the form of a plurality of selected targets.

FIG. 5B shows another screen 510 that may be presented to an advertiser, so that the advertiser may enter bid data and other data for an ad campaign. This screen may be generated after a user has completed the information shown on screen 500 of FIG. 5A. Screen 510 allows the user, for example, to place a start and end date on an ad campaign, and to identify a per-day budget for the campaign. The user may also identify a maximum bid price to be paid per thousand impressions, and that selected Max CPM may be employed in later auctions for the advertising rights for a particular ad slot.

Also, as shown, a “suggested bid” has been computed for the user. The bid may have been computed, such as using the techniques described above, based on the data entered by the user on screen 500, but after the user chose to move from screen 500 to screen 510. The user is also provided a button to calculate estimates of weekly ad campaign costs. Selection of such button may result in a system applying the user's bid amount to targets like those identified by the user on screen 500, using techniques like those discussed above. By selecting the button, the user may quickly see the economic impact of his or her decision, and may return to adjust certain input parameters so that the campaign better matches the user's goals. For example, if the costs are too high, or too few ads can be shown for the budget, the user may return to screen 500 and select less central dayparts (e.g., non-prime time) or smaller networks, or may submit smaller bids on screen 510.

FIG. 5C shows one exemplary screen 520 that results when a user selects the “Calculate Weekly Expenses” button of screen 510. In this example, a table has been generated that includes estimated impressions for each future ad, and also an estimated cost based on the user's bid and the estimated impressions.

FIG. 5D shows yet another screen 530 by which a user can edit the bids for particular showings of an ad. Specifically, the user may have initially entered a single bid for an ad, and a system may have then identified a number of showings for the ad using that bid. The user, however, may recognize that certain showings (e.g., those in the late night or early morning) do not warrant such a high bid, and may want to adjust the general overall bid to provide closer tracking on a showing-by-showing basis. Thus, using screen 530, the user may change the bids and may then re-run certain ad cost estimations described above, to determine if such changes saved money, and whether (and to what extent) they altered the success of the ads in simulated auctions.

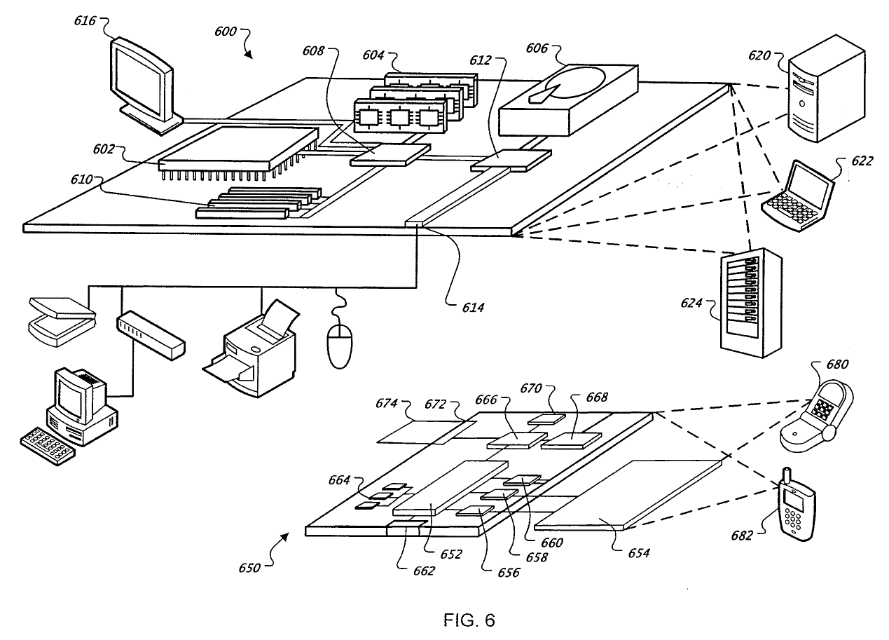

FIG. 6 shows an example of a generic computer device 600 and a generic mobile computer device 650, which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to television advertisements, but other forms of future, viewership-based advertisements may also be addressed, such as radio advertisements and on-line video advertisements.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented advertising management process, comprising:
receiving one or more indicators for a daypart or network on which to run a broadcast advertisement, and a proposed impression-based payment amount for running the advertisement;
identifying one or more historical advertisement slots associated with the one or more indicators and applying the impression-based payment amount to advertising data for the one or more historical advertisement slots; and
reporting an estimated advertising cost of running the advertisement using the impression-based payment amount and impression estimates derived from the advertising data for the one or more historical advertisement slots.

2. The method of claim 1, wherein the historical advertisement slots match the received daypart.

3. The method of claim 2, wherein the historical advertisement slots match the received network.

4. The method of claim 1, wherein the historical advertisement slots match a program associated with the received daypart and network, and an episode of a program having a close match to the daypart or network.

5. The method of claim 1, wherein applying the impression-based payment amount to advertising data for the one or more historical advertisement slots comprises submitting the payment amount against payment amounts for advertisements that ran in the one or more historical advertisement slots to determine an auction-based payment amount for running the advertisement.

6. The method of claim 5, further comprising, multiplying the auction-based payment amount by an impressions level corresponding to the one or more historical advertisement slots.

7. The method of claim 6, wherein the one or more historical advertisement slots comprise an advertisement pod having approximately the same daypart as the received daypart, on the received network.

8. The method of claim 6, wherein the impressions level is computed by adjusting a number of impressions for the one or more historical advertisement slots by a seasonal modifier.

9. The method of claim 1, further comprising generating a bid estimate for providing a determined likelihood of winning an auction for the received daypart or network, using bids of advertisements that ran in the one or more historical advertisement slots.

10. The method of claim 9, wherein generating the bid estimate comprises computing a value between a highest and a lowest bid of advertisements that ran in the one or more historical advertisement slots.

11. The method of claim 1, further comprising determining a charge for an advertiser using a bid winning amount that is based on the impression-based payment amount, multiplied by measured, actual estimated impressions of the advertisement.

12. The method of claim 11, wherein the determined charge is capped at an amount higher than the bid amount multiplied by the estimated impressions.

13. A computer-implemented advertising cost estimation system, comprising:
an ad estimator interface to receive user input regarding advertising slots for the display of future advertisements, and bid amounts associated with the future advertisements;
a historical impressions database storing impressions data associated with timeslots and networks; and
a viewer estimator adapted to identify historical data, in the historical impressions database, associated with the user input regarding advertising slots, and to estimate a number of impressions for the future advertisements using the historical data.

14. The system of claim 13, wherein the timeslots in the historical impressions database correspond to advertising pods.

15. The system of claim 14, wherein the viewer estimator is adapted to compute an average impression level for a pod corresponding to the advertising slot.

16. The system of claim 13, further comprising an auction simulator adapted to apply the bid amounts associated with the future advertisements against bid amounts from the historical impressions database to determine an advertising position for the future advertisements.

17. The system of claim 13, further comprising an auction simulator adapted to compute a suggested bid amount that is likely to generate a winning bid for the future advertisements.

18. A computer-implemented advertising cost estimation system, comprising:
an ad estimator interface to receive user input regarding advertising slots for the display of future advertisements, and bid amounts associated with the future advertisements;
a historical impressions database storing impressions data associated with timeslots and networks; and
means for computing estimated impression-based costs for the future advertisements.
